(19) United States
(12) Patent Application Publication
(10) Pub. No.: US 2025/0197121 A1
(43) Pub. Date: Jun. 19, 2025

(54) CONVEYOR BELT LIFTER

(71) Applicant: ASGCO Manufacturing, Inc., Nazareth, PA (US)

(72) Inventors: Ezra T. NEFF, Walnutport, PA (US); Andrew M. COLLIER, Whitehall, PA (US)

(21) Appl. No.: 18/980,197

(22) Filed: Dec. 13, 2024

Related U.S. Application Data
(60) Provisional application No. 63/610,520, filed on Dec. 15, 2023.

(51) Int. Cl. B65G 15/08; B65G 15/60

(52) U.S. Cl. CPC B65G 15/08; B65G 15/60

(57) ABSTRACT

An apparatus/method for a conveyor belt lifter that can be configured to accommodate conveyor belts of different trough angles. The apparatus includes a pair of scissor lifts coupled to their top ends to a center support while being coupled to an adjustable on their lower ends. The center support has angled wing supports on opposite ends of the center support. The wing supports have side flanges with three distinct apertures located on an elbow portion on a lower end of the flange. A wing linkage is coupled at one end to a respective scissor lift. The other end of the wing linkage is coupled to one of the three distinct apertures, depending on the desired angle of the wing supports, 0°, 20°, 35° and 45°. A threaded rod is passed through the hinge portions of the scissor lifts and then rotated to raise or lower the center support-wing supports assembly.

### CROSS-REFERENCE TO RELATED APPLICATIONS

This non-provisional application claims the benefit under 35 U.S.C. § 119 (e) of Application Ser. No. 63/610,520 filed on Dec. 15, 2023 entitled CONVEYOR BELT LIFTER and whose entire disclosure is incorporated by reference herein.

### BACKGROUND OF THE INVENTION

The present invention relates generally to conveyor belt systems and more particularly, to an apparatus and method for raising trough-shaped conveyor belts.

Conveyor belts are used in a variety of industries to transport materials from one place to another. Generally, materials are deposited at one end of a conveyor and are transported to the other end, where they are discharged or otherwise removed from the conveyor belt. To assist in containing the material upon the conveyor belt during transport, the conveyor belt can be formed into a trough configuration. This is typically accomplished via the use of a center roller having angled idlers on each side of the center roller (see U.S. Pat. No. 9,469,480 (Gibbs) and U.S. Pat. No. 2,225,276 (Parker)) or by having a Y-shaped support having idlers on each leg of the upper portion of the “Y” (see U.S. Pat. No. 6,405,854 (Cumberlege)). See also U.S. Pat. No. 1,705,558 (Cuddihy); U.S. Pat. No. 1,963,099 (Robins); U.S. Pat. No. 2,561,641 (Thomson); U.S. Pat. No. 2,815,851 (Yoshimura) and U.S. Pat. No. 6,173,830 (Cumberlege, et al.).

Additionally, when it becomes necessary to conduct maintenance on different portions of the conveyer belt system or the belt itself, it is necessary lift a portion the conveyor belt off of the belt system, viz., off of the idler devices upon which the belt rides during normal operation. Examples of such devices are disclosed in U.S. Pat. No. 6,109,428 (Harm); U.S. Pat. No. 6,193,052 (Cloud, et al.); U.S. Pat. No. 6,244,428 (Atkins); U.S. Pat. No. 8,186,651 (Dowling); U.S. Pat. No. 7,810,788 (DeVries); U.S. Pat. No. 7,905,341 (Veno); U.S. Pat. No. 9,260,247 (Miller, et al.); U.S. Pat. No. 9,428,372 (Arif); U.S. Pat. No. 9,682,824 (Peters, et al.); U.S. Pat. No. 10,071,860 (Kahrger, et al.); U.S. Pat. No. 10,384,873 (Kilibarda, et al.); U.S. Pat. No. 11,242,204 (Zsido, et al.) and U.S. Pat. No. 11,661,285 (Zsido, et al.).

While the devices disclosed in the aforementioned publications may be generally suitable for their intended purposes, these devices do not allow for manual adjustment for accommodating troughed conveyor belts of different angles. Thus, there remains a need for a conveyor belt lifter device that can be manually-adjusted to accommodate troughed conveyor belts of different angles. All references cited herein are incorporated herein by reference in their entireties.

### BRIEF SUMMARY OF THE INVENTION

An apparatus for lifting a portion of trough-shaped conveyor belts of different trough angles when a trough-shaped conveyor belt is installed in a conveyor system is disclosed. The apparatus comprises: a conveyor belt lifting surface for receiving thereon a portion of a trough-shaped conveyor belt having a trough angle, and wherein the conveyor belt lifting surface comprises a center support with a first angled wing support and a second wing support on opposite sides of the center support, wherein the first angled wing support and the second wing support are adjustable to the trough angle (e.g., 0°, 20° or 35° or) 45°; a pair of scissor lifts wherein a respective scissor lift is coupled to a respective end of the center support for raising or lowering the conveyor belt lifting surface, each of the scissor lifts having a first scissor bracket and a second scissor bracket, wherein the first scissor bracket has an upper portion and a lower portion hinged together to form a first hinge and wherein the second scissor bracket also includes an upper portion and a lower portion that are also hinged together to form a second hinge, wherein the first and second hinges move in opposite directions during the raising or lowering; a threaded rod that passes through the first and second hinges of each of the pair of scissor lifts and wherein the threaded rod is threadedly engaged with the first hinges of the pair of scissor lifts for permitting activation of the pair of lifts to raise or lower the conveyor belt lifting surface; and a base to which the pair of lifts is coupled, the base being adjustable to rest on a portion of the conveyor system.

A method of lifting a portion of trough-shaped conveyor belts of different trough angles when a trough-shaped conveyor belt is installed in a conveyor system is disclosed. The method comprises: forming a conveyor belt lifting surface comprised of a center support with a first angled wing support and a second wing support on opposite sides of the center support, wherein the first angled wing support and the second wing support are adjustable to a trough angle (e.g., 0°, 20° or 35° or) 45° of the trough-shaped conveyor belt; coupling a first scissor lift and a second scissor lift to respective ends of the center support for raising or lowering the conveyor belt lifting surface, and wherein each of the scissor lifts comprises a first scissor bracket and a second scissor bracket, wherein the first scissor bracket has an upper portion and a lower portion hinged together to form a first hinge and wherein the second scissor bracket also includes an upper portion and a lower portion that are also hinged together to form a second hinge, and wherein the first and second hinges move in opposite directions during the raising or lowering; coupling the lower ends of the scissor jacks to a base that is adjustable to rest on a portion of the conveyor system; inserting a threaded rod through the first hinges and second hinges of each of the pair of scissor lifts and threadedly engaging the threaded rod with the first hinges of the pair of scissor lifts for permitting activation of the pair of lifts to raise or lower the conveyor belt lifting surface; and positioning the conveyor belt lifting device underneath the trough-shaped conveyor belt and mounting the base to the conveyor system to receive a portion of the trough-shaped conveyor belt having the trough angle onto the conveyor belt lifting surface.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an isometric view of the conveyor belt lifter (CBL) of the present invention shown in its fully erect state, referred to as its “raised position”;

FIG. 2 is a front view of the CBL with the wing linkages' upper ends not connected to the respective wing supports and with the scissor jacks fully extended upward for raising a conveyor belt that is flat, i.e., not troughed at a 0°;

FIG. 3A is a front view of the CBL in its fully extend “raised position” and having the wing supports located at a 20° trough angle, by way of example only;

FIG. 3B is a front view of the CBL in its raised position and having the wing supports located at a 35° trough angle, by way of example only;

FIG. 3C is front view of the CBL in its raised position and having the wing supports located at a 45° trough angle, by way of example only;

FIG. 4A is an end view of the CBL taken from the left in accordance with site line 4A-4A shown in FIG. 4B;

FIG. 4B is a view of the CBL taken along line 4B-4B of FIG. 4A behind the wing linkages to better show the threaded rod drive assembly;

FIG. 5A is a front view of the CBL shown in in its folded position with the front left and right extensions extended partially out of the front base portion;

FIG. 5B is an isometric view of the CBL shown in in its folded position with the left/right extensions extended partially of their respective base portions;

FIG. 6A is a front view of the CBL in its raised position with the wing supports at the 35° trough angle, by way of example only;

FIG. 6B an isometric view of the CBL in its raised position with the wing supports at the 35° trough angle, by way of example only;

FIG. 7A is a front view of the CBL but shown in a partially-raised position;

FIG. 7B is an isometric view of the CBL of FIG. 7A;

FIG. 8A is a front view of the CLB of FIGS. 5A-5B in the folded position but with the front left/right extensions completely retracted within the front base portion;

FIG. 8B an isometric view of the CLB of FIG. 8A;

FIG. 8C is an end view of the CLB taken along line 8C-8C of FIG. 8A;

FIG. 9A is a front view of the CLB in the folded position and but with the front left/right extensions fully extended out of the front base portion;

FIG. 9B is an isometric view of the CLB of FIG. 9A;

FIG. 10A is a side view of a preferred embodiment of the non-threaded and threaded extrusions;

FIG. 10B is an end view of the non-threaded and threaded extrusions;

FIG. 10C is an isometric view of the preferred embodiment of the non-threaded and threaded extrusions;

FIG. 10D is a view of the non-threaded extrusion installed in the conveyor belt lifter taken along line 10D-10D of FIG. 3C;

FIG. 10E is an enlarged view of the mounted threaded extrusion of FIG. 10D;

FIG. 11A is an isometric view of an alternative embodiment of the non-threaded extrusion comprising a hex bar configuration;

FIG. 11B is an end view of the of the non-threaded hex bar extrusion and the threaded extrusion of FIG. 11A;

FIG. 11C is a side view of the alternative embodiment of FIG. 11A;

FIG. 11D is also a side view of the alternative embodiment of FIG. 11A but with a disc spring (e.g., a Belleville washer) positioned between the hex bar and the threaded extrusion;

FIG. 12A is an isometric view of a second alternative to the non-threaded and threaded extrusions which comprises a threaded hex bar extrusion;

FIG. 12B is an end view of the threaded hex bar extrusion; and

FIG. 12C is a side view of the threaded hex bar extrusion.

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

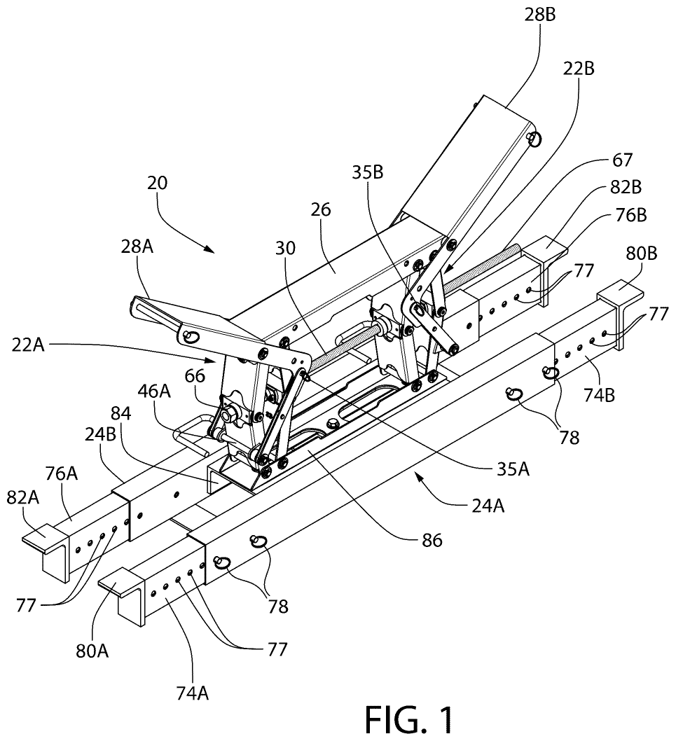

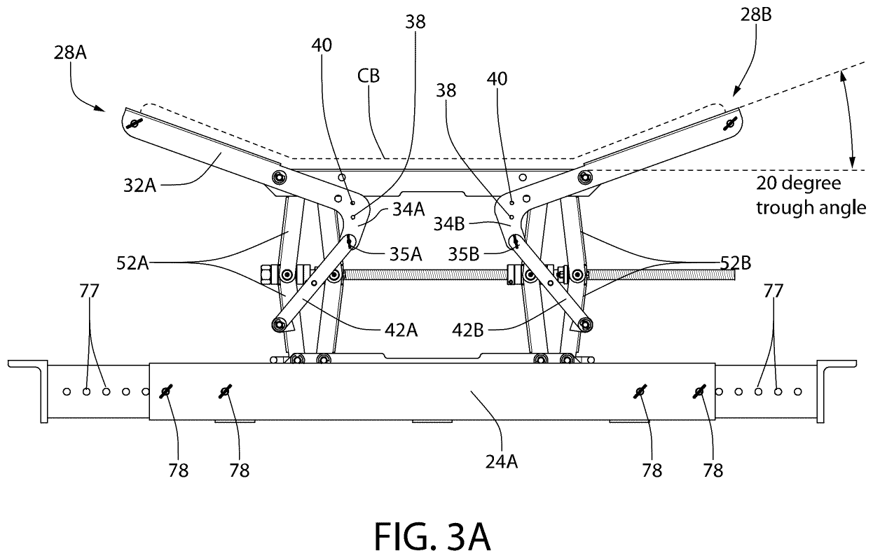

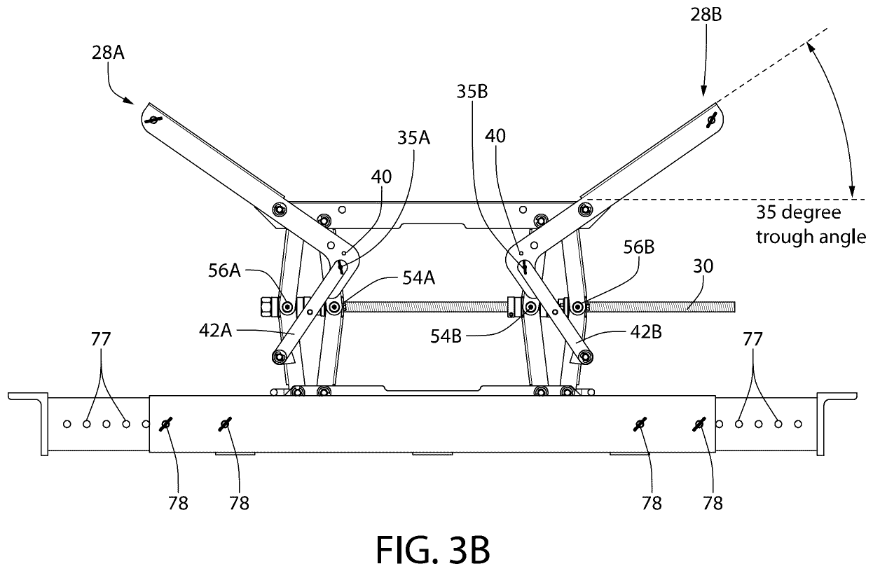

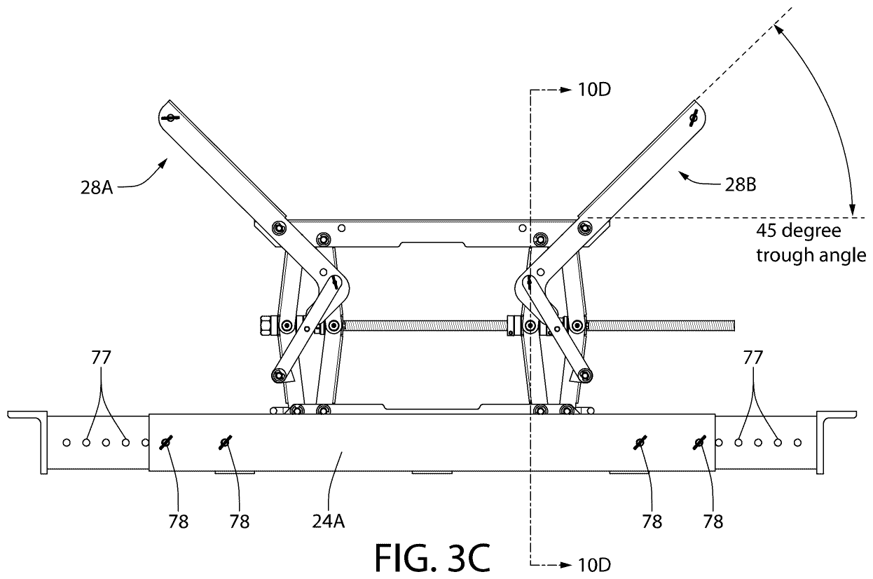

As mentioned previously, many conveyor belts CB (see FIG. 3A for example) are formed into a trough configuration for conveying payloads. The typical trough angles used in various industries are 0°, 20°, 35° and 45°. One of the key features of the present invention is a conveyor belt lifter (CBL) 20, as shown in FIG. 1, that provides the operator with the ability to easily configure the CBL 20 to any of these three trough angles.

It should be noted that the use of terms “left” and “right” refer to the view in FIG. 1 and is for ease of reference only; the CBL 20 can be oriented in a conveyor belt system (not shown) without particular need to match a particular side of the CBL 20 to a particular side of the conveyor belt CB. As such, use of the letter “A” in the reference characters typically refers to the “left” side of the CBL 20 or the front side of the CBL 20 and the use of the letter “B” in the reference characters typically refers to the “right” side of the CBL 20 or the rear side of the CBL 20.

FIG. 1 depicts the CBL 20 configured to the 35° setting, by way of example only, and its deployed condition for lifting a conveyor belt (see FIG. 3A) configured with a 35° trough angle. As can be seen therein, the CBL 20 comprises a pair of scissor jacks 22A/22B (also referred to as “scissor lifts”) mounted to an adjustable base assembly, the central portion of which is referenced to as base (or base portion) 24A/24B in the front and rear of the CBL 20, respectively; these base portions 24A/24B also serve as housing for left/right extensions that can extend out of, or retract into, these base portions, as will be discussed later. The upper ends of the jacks 22A/22B are mounted to a center support 26 which holds the center portion of the troughed conveyor belt thereon. Wing supports 28A/28B are pivotally mounted to respective ends of the center support 26 and the wing supports 28A/28B support the angled portions of the troughed conveyor belt thereon. Thus, the center support 26 and wing supports 28A/28B together form the belt lifting surface. A threaded rod 30 passes through the hinge portions of both scissor jacks 22A/22B and is used for raising or lowering the belt lifting surface, as will be discussed later.

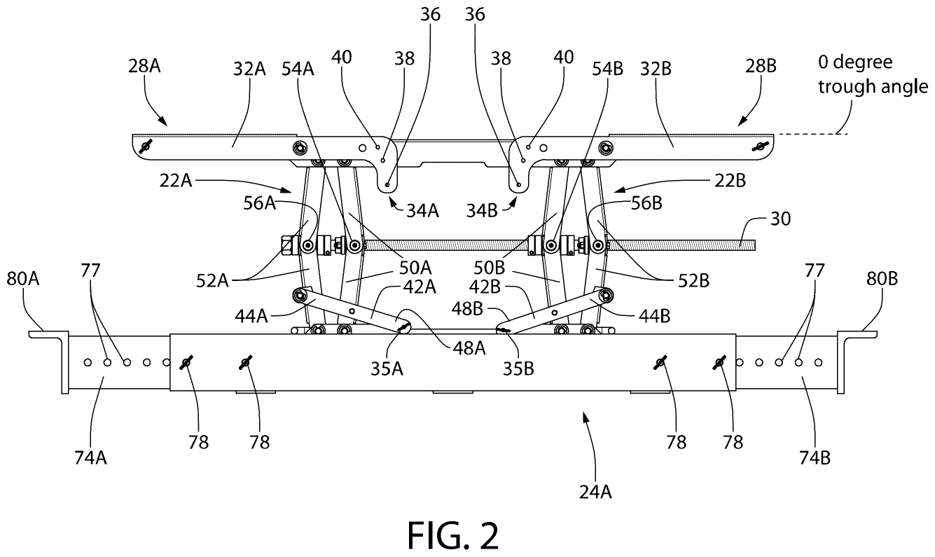

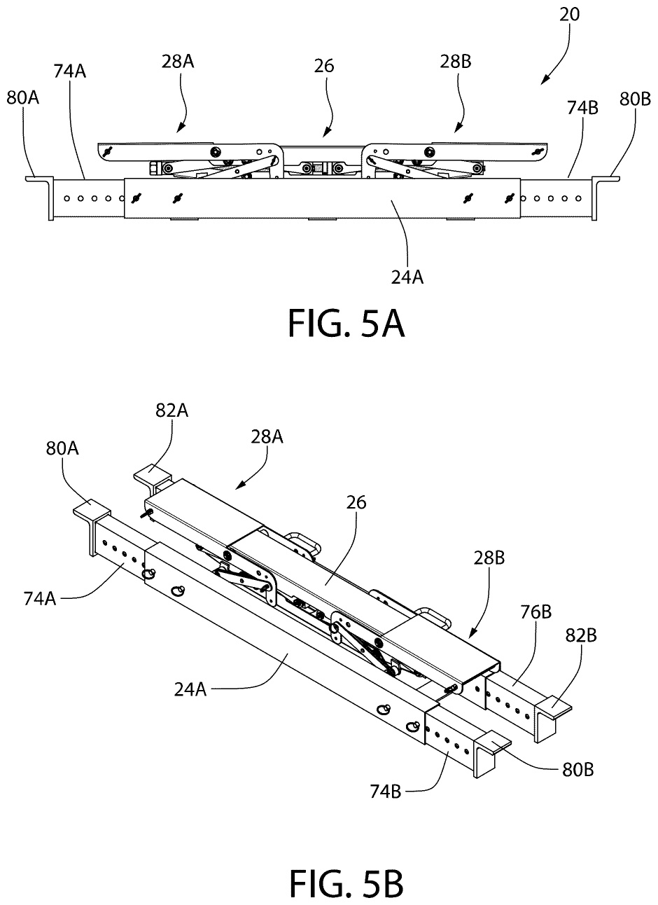

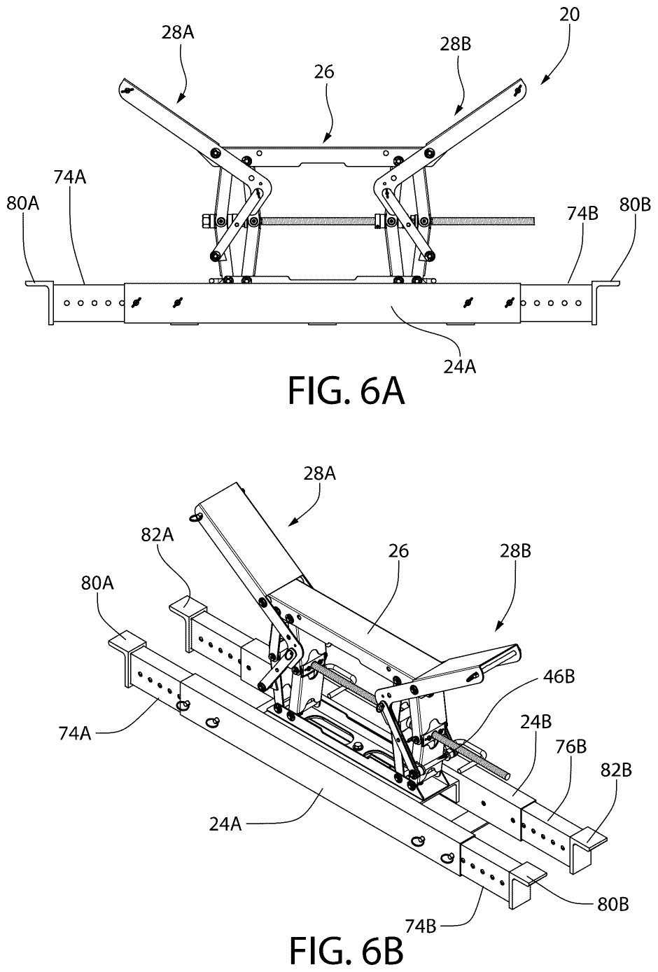

To provide the operator of the CBL 20 with an easy manner to select a particular trough angle, as shown most clearly in FIG. 2, each wing support 28A/28B comprises a respective side flange 32A and 32B, each having a respective elbow end 34A and 34B (FIG. 2). Each elbow end 34A/34B comprises three apertures 36, 38 and 40. A respective wing linkage 42A and 42B have a respective first end 44A and 44B that are pivotally connected to a respective connecting rod 46A (FIG. 1) and 46B (FIG. 6B) of the respective scissor jacks 22A/22B; these connecting rods 46A/46B are secured to the lower portion of the outer scissor jack brackets 52A/52B (FIG. 3A). It is the connection of a second end 48A/48B of the wing linkages 42A/42B that provide the operator with the ability to configure the CBL 20 to a desired trough angle (20°, 35° and) 45°; the operator uses a fastener 35A/35B (e.g., quick release pin, bolt/nut, etc.; see FIG. 5B) to releasably secure the second end 48A/48B to the corresponding elbow 34A/34B in the particular aperture 36, 38 or 40. As shown most clearly in FIGS. 3A-3C, when the second ends 48A/48B are coupled to respective apertures 36, the CBL 20 is configured to lift a troughed conveyor belt (not shown) having a trough angle of 20° (FIG. 3A); when the second ends 48A/48B are coupled to respective apertures 38, the CBL 20 is configured to lift a troughed conveyor belt (not shown) having a trough angle of 35° (FIG. 3B); and when the second ends 48A/48B are coupled to respective apertures 40, the CBL 20 is configured to lift a troughed conveyor belt (not shown) having a trough angle of 45° (FIG. 3C).

As can be seen in FIG. 2, when the second ends 48A/48B of the wing linkages 42A/42B are not connected to the elbow ends 34A/34B, the CBL 20 is then configured to lift a conveyor belt that has a trough angle of 0° (i.e., the conveyor belt, not shown, is flat and not troughed, with the wing supports 28A/28B being aligned with the center support 26. Although not shown, the second ends 48A/48B may be connected to the center support 26 when configuring the CBL 20 to lift a conveyor belt with trough angle of 0°.

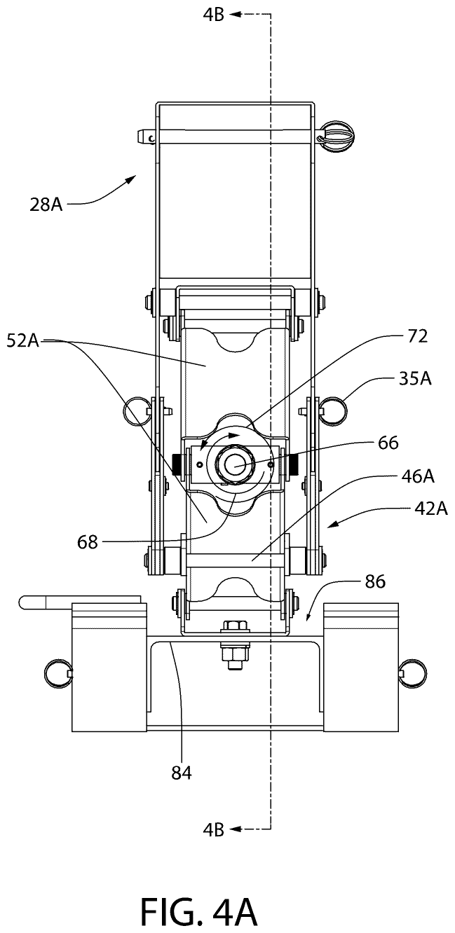

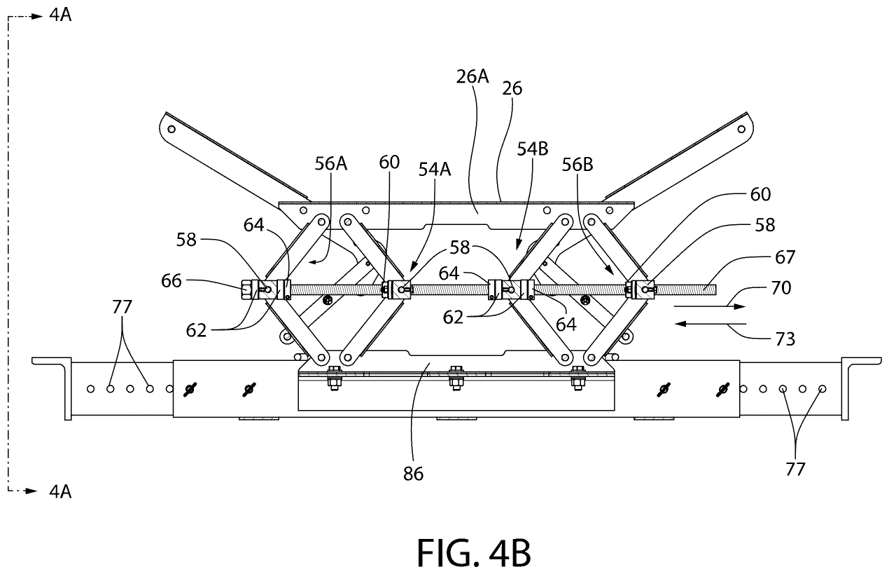

It should be understood that the flanges 32A/32B, the elbow ends 34A/34B, the three apertures 36, 38 and 40, the wing linkages 42A/42B, the first ends 44A/44B and the second ends 48A/48B are all duplicated on the opposite side of the CBL 20, as best shown in FIGS. 4A-4B. Hence, the purpose of the connecting rods 46A/46B is to connect the first ends 44A/44B of the wing linkages 42A/42B to the first ends of their “mirror wing linkages” on the other side of the CBL 20.

Each scissor jack 22A/22B comprises respective inner scissor brackets 50A/50B and respective outer scissor brackets 52A/52B, shown most clearly in FIG. 2. Each inner bracket 50A/50B comprises an upper portion and a lower portion that are hinged together at respective inner hinges 54A/54B (FIG. 2) and each outer bracket 52A/52B also comprises an upper and a lower portion that are hinged together at respective outer hinges 56A/56B (FIG. 2). As best can be seen in FIG. 4B, the upper portions of the inner brackets 50A/50B and the upper portions of the outer brackets 52A/52B are pivotally connected to a side flange 26A of the center support 26. The lower portions of the inner brackets 50A/50B and the lower portions of the outer brackets 52A/52B are pivotally connected to a scissors jack mounting bracket 86. Thus, the first scissors jack 22A is coupled to one end of the center support 26 and the second scissors jack 22B is coupled to the other end of the center support 26.

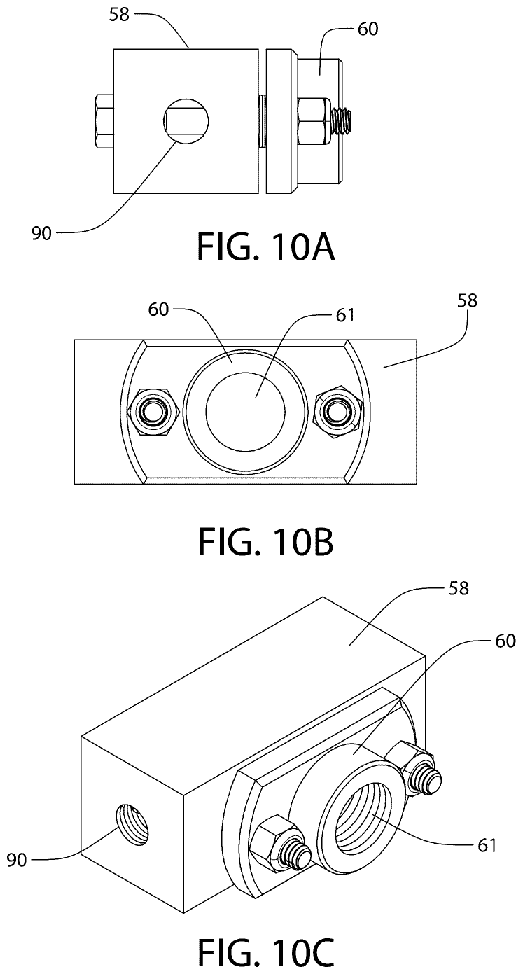

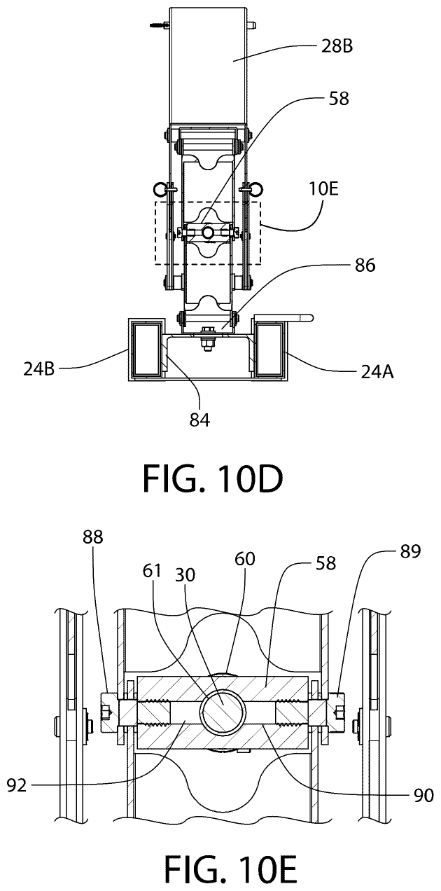

To control the scissor jacks 22A/22B simultaneously, the threaded rod 30 passes through all of the hinges 54A, 54B, 56A and 56B. In FIG. 4B (which is taken along site line 4B-4B of FIG. 4A), the flanges 32A/32B and wing linkages 42A/42B are not shown to more clearly depict the threaded rod 30 interface with the scissor jacks 22A/22B. As can be seen in FIG. 4B, at each of the hinge locations, a non-threaded extrusion 58 is located through which the rod 30 passes. With particular regard to the hinge 54A of the inner left brackets 50A and the hinge 56B of the outer right brackets 52B, as shown in FIG. 4B, a non-threaded extrusion 58 having a threaded extrusion 60 coupled thereto is mounted; enlarged views of this non-threaded extrusion 58/threaded extrusion 60 can best be seen in FIGS. 10A-10C. As for the hinge 56A of the outer left brackets 52A and the hinge 54B of the inner right brackets 50B, the non-threaded extrusion 58 is mounted with thrust bearings 62 located at each end of the extrusion 58. At hinge 54B, a lead screw collar 64 is secured against respective thrust bearings 62. At hinge 56A, a lead screw collar 64 is mounted against the thrust bearing 62 on the inner side of the hinge 56A while a nut 66 is secured against the thrust bearing 62 on the outer side of the hinge 56A. The drive end of the rod 30 is at the nut 66 and as such, reference number 66 refers to either the nut or drive end of the rod 30, whereas reference number 67 indicates the free end of the threaded drive rod 30. The lead screw collars 64 are internally threaded to maintain position on the threaded drive rod 30. Once their positions are set, these lead screw collars 64 can be permanently clamped around the threaded drive rod 30 in order to keep their position. As a result, there is no relative movement between the threaded drive rod 30 and the non-threaded extrusions 58 at hinges 56A and 54B. In contrast, the threaded drive rod 30 does engage the threads within the threaded extrusions 60 at hinges 54A and 56B. As such, rotation of the threaded drive rod 30 within the threaded extrusions 60 is what activates the scissors jacks 22A/22B to expand or retract in order to raise or lower them. And since there is no relative movement between threaded drive rod 30 and the non-threaded extrusions 58 at hinges 56A and 54B, the movement of non-threaded extrusions 58 with the rod 30 drives the respective brackets (52A at hinge 56A, and 50B at hinge 54B) to expand or collapse accordingly.

When the drive end 66 of the rod 30 is turned in a first direction 68 (FIG. 4A), the threaded rod 30 moves to the right 70 (FIG. 4B), causing the brackets 52A/50A of scissors jack 22A to expand and the brackets 50B/52B to expand, thereby simultaneously raising the scissor jacks 22A/22B. This causes the center support 26 to rise and the wing supports 28A/28B to move towards their desired trough angle. When the threaded extrusions 60 come into contact with the lead screw collars 64 (see FIG. 2 for example), this acts to stop any further expansion of the brackets 52A/50B and 50B/52A and the wing supports 28A/28B come to rest at the desired trough angle, and establishes the raised position of the CBL 20. Conversely, when the drive end 66 of the rod 30 is turned in an opposite second direction 72 (FIG. 4A), the rod 30 moves to the left 73 (FIG. 4B), causing the brackets 52A/50B and 50B/52A to fold, thereby simultaneously lowering the scissor jacks 22A/22B to cause the wing supports 28A/28B to rotate towards a horizontal position, similar to the center support 26 and thereby fold the CBL 20 into a parallel position with, and on top of, the base portion 24A/24B (FIGS. 5A-5B), referred to as the “folded position”. When the non-threaded extrusion 58 of hinge 54A contacts the lead screw collar 64 on hinge 54B, the folded position is reached.

As can also be appreciated, when the scissors jacks 22A/22B are raising the center support 26, hinges 54A and 56B move in the direction 73 while hinges 56A and 54B move in the direction 70. Conversely, when the scissor jacks 22B/22B are lowering the center support, hinges 54A and 56B move in the direction 70 and hinges 56A and 54B move in the direction 73. As will be discussed in detail later, threaded extrusions 60 are located at hinges 54A and 56B for activating the scissor jacks 22A/22B, while pulling or pushing the other hinges 56A and 54B using non-threaded extrusions 58, to raise or lower the center portion 26.

As shown most clearly in FIG. 1, the base assembly is also adjustable, thereby allowing the CBL 20 to be installed within any conveyor system underneath the conveyor belt (not shown) in order to accommodate conveyor systems of different widths. This is accomplished with extensions that can extend from, or retract into, the base portion. In particular, the front base 24A comprises left and right extensions 74A and 74B respectively, and the rear base 24B comprises left and right extensions 76A and 76B, respectively. Each extension comprises a plurality of apertures 77, any two adjacent ones of which can be aligned with corresponding apertures in the corresponding base (i.e., 24A or 24B) for receipt of quick release pins 78 therein. Thus, using the quick-release pins 78, this permits the operator to adjust the length of the overall base support by releasably fixing extensions (that extend from, or retract within, the base 24A/24B) at particular lengths having apertures 77 for receiving the quick-release pins 78 therein. Front conveyor base supports 80A/80B are fixed to the ends of the front extensions 74A/74B and rear conveyor base supports 82A/82B are fixed to the ends of rear extensions 76A/76B to permit the CBL 20 to rest on the conveyor belt system supports (not shown).

In between the bases 24A/24B is located a jack pedestal 84 for the jacks 22A/22B. The scissor jacks 22A/22B are mounted to the pedestal 84 using the scissor jack mounting bracket 86.

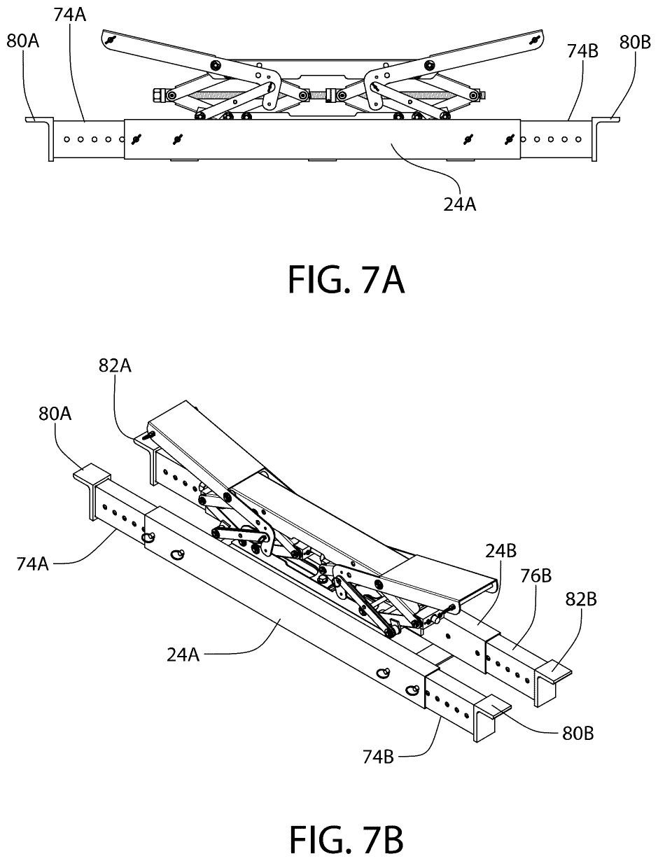

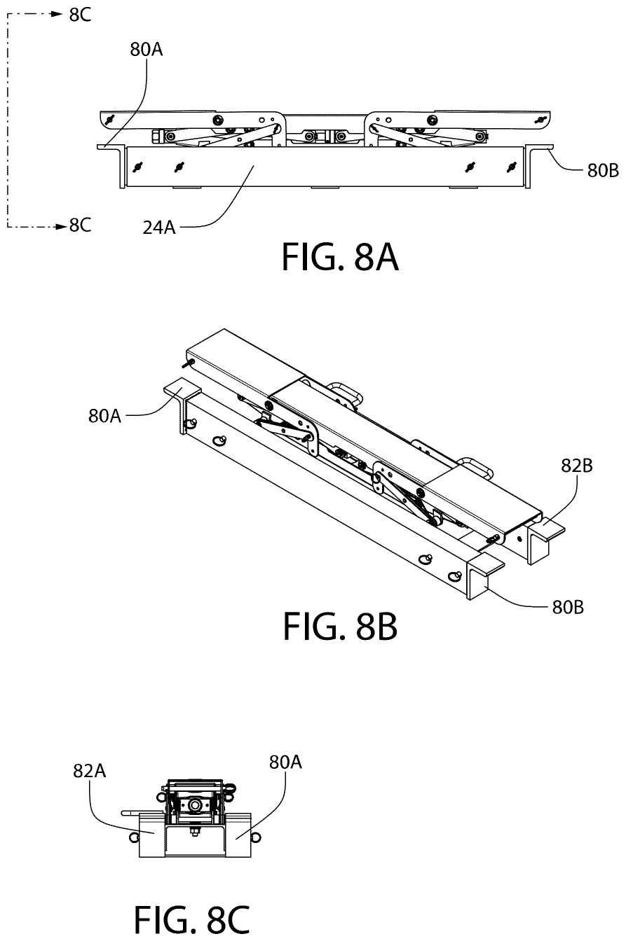

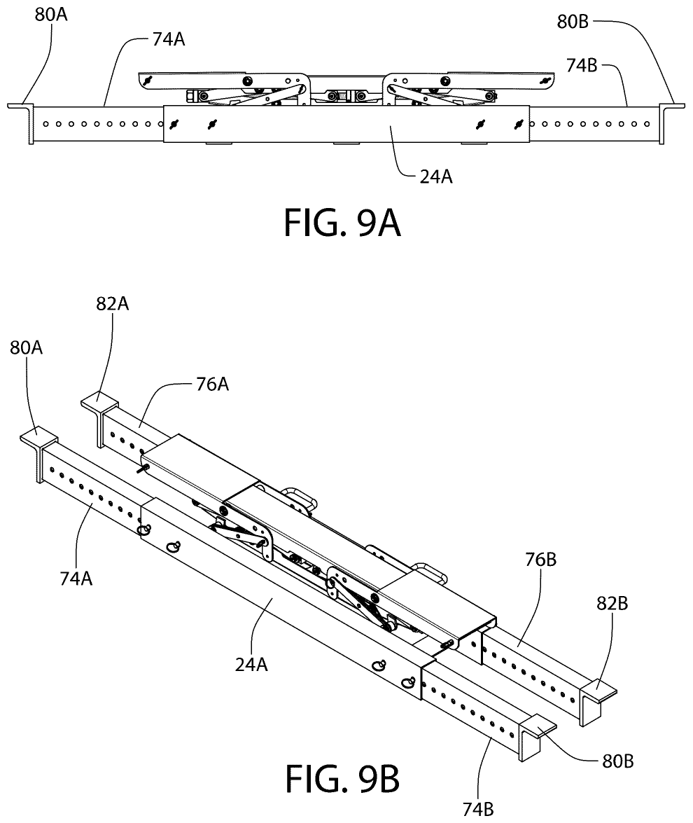

FIGS. 5A-5B depict the CBL 20 in its fully collapsed position and with the front extensions 74A/74B and the rear extensions 76A/76B shown partially extended from their respective bases 24A/24B. FIGS. 6A-6B depict the CBL 20 in its fully raised position using a 35° trough angle (since aperture 38 has been used to connect the second ends 48A/48B of the respective wing linkages 42A/42B) for the wing supports 28A/28B, by way of example only. FIGS. 7A-7B depict the CLB 20 partially raised and with the front extensions 74A/74B and rear extensions 76A/76B shown partially extended from their respective bases 24A/24B. FIGS. 8A-8B, like FIGS. 5A-5B, depict the CBL 20 in its “folded position” but with the front extensions 74A/74B and rear extensions 76A/76B shown fully retracted within their respective bases 24A/24B; the respective base supports (80A/80B and 82A/82B) act as stops, being in contact with the outer ends of the respective bases 24A/24B; FIG. 8C is a left end view of the folded CBL 20. FIGS. 9A-9B depict the CBL 20 in its folded position and with the front extensions 74A/74B and the rear extensions 76A/76B shown in the fully extended positions.

### The Non-Threaded Extrusion 58 and Threaded Extrusion 60

As discussed previously, the threaded extrusion 60 forms an important component for the CBL 20 since it controls the folding and expansion of the scissor jacks 22A and 22B when the threaded rod 30 is rotated in respective directions (68/72, FIG. 4A). As mentioned previously, FIGS. 10A-10C depict enlarged views of the non-threaded extrusion 58 and the threaded extrusion 60 coupled thereto. The non-threaded extrusion 58, which is rectangular in form, is mounted at all of the hinges 54A/56A and 54B/56B. By way of example, FIGS. 10D-10E show how the non-threaded extrusion 58 is mounted at one of the hinges using threaded bolts 88 and 89 (FIG. 10E) that secure within threaded mounting holes 90 and 92 in the non-threaded extrusion 58. The two mounting holes 90/92 and bolts 88/89 are limited in length so as not to interfere with a through-hole 61 (FIGS. 10B and 10E) for receipt of the threaded rod 30 therein. The through-hole 61 is orthogonal to the mounting holes 90/92 to permit insertion of the threaded rod 30 in the through-hole 61 without interfering with the rotational mounting of the non-threaded extrusion 58. As discussed above, the threaded rod 30 passes through the threaded extrusion 60 (i.e., through the through-hole 61) for controlling the folding and expansion of the scissor jacks 22A/22B. It should be understood that the through-hole 61 in its broadest sense includes the through-hole through the non-threaded extrusion 58 as well as the passageway through the threaded extrusion 60. As such, the threaded rod 30 engages with the threads in the threaded extrusion 60 and then passes through the non-threaded extrusion 58.

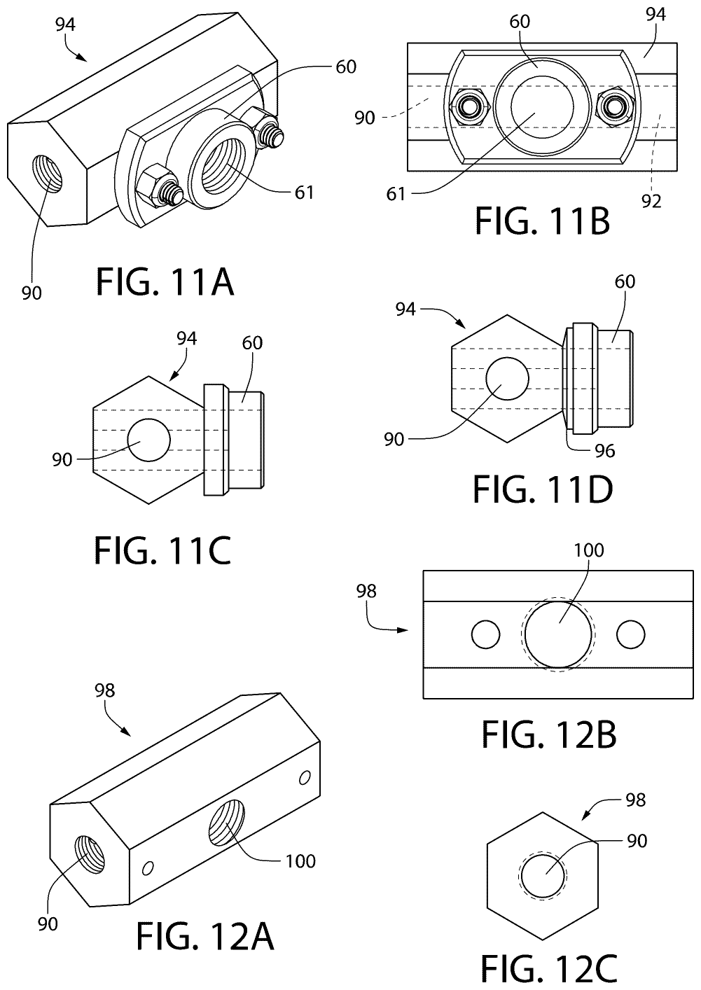

It is possible that the threaded rod 30 could be subject to binding due to slight misalignment of the threaded rod 30 through the two scissor jacks 22A/22B. If so, Applicant has proposed a first alternative to the non-threaded extrusion 58/threaded extrusion 60, namely, a non-threaded hex bar-shaped extrusion 94 coupled to the threaded extrusion 60, as shown in FIGS. 11A-11C. The extrusion 94 includes mounting holes 90 and 92 as discussed previously with non-threaded extrusion 58. Furthermore, a disc spring 96 (e.g., a Belleville washer) positioned between the hex bar 94 and the threaded extrusion 60 may be included. The purpose of the disc spring 96 provides some “play” (e.g., misalignment) between the hex bar 94 and the threaded extrusion 60 to prevent the rod 30 from binding. Disc springs, such as Belleville washers, comprise a compression-spring-like structure. When used in between the hex bar 94 and the threaded extrusion 60, some slight relative movement between these two parts is permitted by the disc spring 96.

A second and more preferred alternative to the threaded extrusion 60, is the threaded extrusion 98 shown in FIGS. 12A-12C. In this alternative, the hex bar 98 comprises a threaded through-hole 100 for receiving the threaded rod 30 therein. In this alternative, there is no need for the threaded extrusion 60 to be attached to the hex bar 94 nor the disc spring 96. Thus, the threaded extrusion 98 is a unitary member which is threadedly coupled to the threaded rod 30.

### REFERENCE CHARACTERS

CB conveyor belt (see FIG. 3A)
20 conveyor belt lifter (CBL)
22A (left) scissor jack (lifter)
22B (right) scissor jack (lifter)
24A front base portion of adjustable base assembly
24B rear base portion of adjustable base assembly
26 center support
26A center support side flange
28A (left) wing support
28B (right) wing support
30 threaded drive rod
32A (left) wing support flange
32B (right) wing support flange
34A (left) flange elbow
34B (right) flange elbow
35A fastener (quick release pin) to secure wing linkage 42A to wing support flange 32A
35B fastener (quick release pin) to secure wing linkage 42B to wing support flange 32B
36 aperture (20°)
38 aperture (35°)
40 aperture (45°)
42A (left) wing linkage
42B (right) wing linkage
44A first end of left wing linkage 42A
44B first end of right wing linkage 42B
46A left wing linkage connecting rod
46B right wing linkage connecting rod
48A second end of left wing linkage 42A
48B second end of right wing linkage 42B
50A inner brackets of left scissor jack
50B inner brackets of right scissor jack
52A outer brackets of left scissor jack
52B outer brackets of right scissor jack
54A hinge of left inner brackets 50A
54B hinge of right inner brackets 50B
56A hinge of left outer brackets 52A
56B hinge of right outer brackets 52B
58 non-threaded extrusion
60 threaded extrusion
61 through-hole in threaded extrusion for drive rod 30
62 thrust bearing
64 lead screw collar
66 nut which is at drive end of rod 30
67 free end of rod 30
68 first direction of rotation of drive end 66
70 right direction
72 second direction of rotation of drive end 66
73 left direction
74A front left extension
74B front right extension
76A rear left extension
76B rear right extension
77 apertures in extensions
78 quick release pins
80A left front conveyor base support for front extension 74A
80B right conveyor base support for r extension 74B
82A left rear conveyor base support for rear extension 76A
82B right conveyor base support for rear extension rod 76B
84 scissors jack pedestal in between bases 24A/24B
86 scissors jack mounting bracket
88 mounting bolt
89 mounting bolt
90 mounting hole
92 mounting hole
94 first alternative non-threaded extrusion
96 disc spring (e.g., Belleville washer)
98 hex bar with threaded through-hole

While the invention has been described in detail and with reference to specific examples thereof, it will be apparent to one skilled in the art that various changes and modifications can be made therein without departing from the spirit and scope thereof.

What is claimed is:

1. An apparatus for lifting a portion of trough-shaped conveyor belts of different trough angles when a trough-shaped conveyor belt is installed in a conveyor system, said apparatus comprising:
a conveyor belt lifting surface for receiving thereon a portion of a trough-shaped conveyor belt having a trough angle, said conveyor belt lifting surface comprising a center support with a first angled wing support and a second wing support on opposite sides of said center support, said first angled wing support and said second wing support being adjustable to said trough angle;
a pair of scissor lifts wherein a respective scissor lift is coupled to a respective end of said center support for raising or lowering said conveyor belt lifting surface, each of said scissor lifts having a first scissor bracket and a second scissor bracket, said first scissor bracket having an upper portion and a lower portion hinged together to form a first hinge and wherein said second scissor bracket also includes an upper portion and a lower portion that are also hinged together to form a second hinge, said first and second hinges moving in opposite directions during said raising or lowering;
a threaded rod that passes through said first and second hinges of each of said pair of scissor lifts and wherein said threaded rod is threadedly engaged with said first hinges of said pair of scissor lifts for permitting activation of said pair of lifts to raise or lower said conveyor belt lifting surface; and
a base to which said pair of lifts is coupled, said base being adjustable to rest on a portion of the conveyor system.

2. The apparatus of claim 1 wherein said trough angle is 0°.

3. The apparatus of claim 1 wherein said trough angle is 20°.

4. The apparatus of claim 1 wherein said trough angle is 35°.

5. The apparatus of claim 1 wherein said trough angle is 45°.

6. The apparatus of claim 1 wherein each angled wing support comprises flanges that form sidewalls on each side of said angled wing support and wherein each flange further comprises a portion that extends beyond said wing support and terminates in an elbow.

7. The apparatus of claim 6 wherein said elbow comprises a plurality of apertures, each one of said apertures configured to receive a fastener for connecting one end of a wing strut thereto, and wherein a second end of said wing strut is connected to said lower portion of said outer scissor bracket, said plurality of apertures being selectable by an operator to adjust said corresponding wing support to said trough angle.

8. The apparatus of claim 7 wherein said trough angle is one angle from the group of angles of 0° and 20° and 35° and 45°.

9. The apparatus of claim 1 wherein said base comprises a pair of base portions, each base portion comprising a pair of extensions that can be releasably adjusted to project out of respective ends of said respective base portions to accommodate conveyor belt supports of different widths.

10. The apparatus of claim 9 wherein an outer end of each of said extensions comprises a conveyor base support for resting on the conveyor system.

11. The apparatus of claim 9 wherein said base portions and their respective extensions comprise a plurality of apertures through which quick-release pins can be releasably secured therethrough for adjusting a length of said base portions.

12. The apparatus of claim 1 wherein said first hinges comprise threaded extrusions thereat for threadedly engaging said threaded rod to activate said pair of scissor lifts to raise or lower said conveyor belt lifting surface when said threaded rod is rotated.

13. The apparatus of claim 12 wherein said threaded extrusion is coupled to a non-threaded extrusion having a through-hole aligned with said threaded extrusion to allow passage of said threaded rod therethrough.

14. The apparatus of claim 13 wherein said non-threaded extrusion comprises a rectangular configuration.

15. The apparatus of claim 13 wherein said non-threaded extrusion comprises a hex bar configuration.

16. The apparatus of claim 15 further comprising a disc spring located between said threaded extrusion and non-threaded extrusion to allow for misalignment between said non-threaded extrusion and said threaded extrusion to prevent said threaded rod from binding.

17. The apparatus of claim 16 wherein said disc spring is a Belleville washer.

18. The apparatus of claim 1 wherein said second hinges comprise a non-threaded extrusion with a through-hole for allowing passage of said threaded rod therethrough, said non-threaded extrusion secured to said threaded rod by a thrust bearing and a lead screw collar located on opposite ends of said non-threaded extrusion.

19. A method of lifting a portion of trough-shaped conveyor belts of different trough angles when a trough-shaped conveyor belt is installed in a conveyor system, said method comprising:
forming a conveyor belt lifting surface comprised of a center support with a first angled wing support and a second wing support on opposite sides of said center support, said first angled wing support and said second wing support being adjustable to a trough angle of the trough-shaped conveyor belt;
coupling a first scissor lift and a second scissor lift to respective ends of said center support for raising or lowering said conveyor belt lifting surface, and wherein each of said scissor lifts comprises a first scissor bracket and a second scissor bracket, said first scissor bracket having an upper portion and a lower portion hinged together to form a first hinge and wherein said second scissor bracket also includes an upper portion and a lower portion that are also hinged together to form a second hinge, and wherein said first and second hinges move in opposite directions during said raising or lowering;
coupling the lower ends of said scissor jacks to a base that is adjustable to rest on a portion of the conveyor system;
inserting a threaded rod through said first hinges and second hinges of each of said pair of scissor lifts and threadedly engaging said threaded rod with said first hinges of said pair of scissor lifts for permitting activation of said pair of lifts to raise or lower said conveyor belt lifting surface; and
positioning said conveyor belt lifting device underneath the trough-shaped conveyor belt and mounting said base to the conveyor system to receive a portion of the trough-shaped conveyor belt having said trough angle onto said conveyor belt lifting surface.

20. The method of claim 19 wherein said trough angle is 0°.

21. The method of claim 19 wherein said trough angle is 20°.

22. The method of claim 19 wherein said trough angle is 35°.

23. The method of claim 19 wherein said trough angle is 45°.

24. The method of claim 19 wherein step of forming a conveyor belt lifting surface comprises forming sidewalls on each angled wing support and wherein each sidewall further comprises a portion that extends beyond said wing support and terminates in an elbow.

25. The method of claim 24 wherein said step of forming sidewalls comprises a including a plurality of apertures in said elbow, each one of said apertures configured to receive a fastener for connecting one end of a wing strut thereto, and wherein a second end of said wing strut is connected to said lower portion of said outer scissor bracket, said plurality of apertures being selectable by an operator to adjust said corresponding wing support to said trough angle.

26. The method of claim 25 wherein said trough angle is one angle from the group of angles of 0° and 20° and 35° and 45°.

27. The method of claim 19 wherein said step of positioning said conveyor belt lifting device underneath the trough-shaped conveyor belt comprises:
providing a pair of base portions to form said base and providing a pair of extensions for each of said base portions that can be releasably adjusted to project out of respective ends of said respective base portions;
extending or retracting said extensions out said respective ends of said respective base portions to accommodate a width of the conveyor system; and
releasably securing said extensions at a desired distance to accommodate the width of the conveyor system.

28. The method of claim 27 wherein each of said extensions have free ends comprising a conveyor base support, said conveyor base support configured to rest on a portion of the conveyor system.

29. The method of claim 27 wherein step of releasably securing said extensions comprises inserting quick-release pins through apertures in said base portions and through apertures in said extensions.

30. The method of claim 19 wherein said step of inserting said threaded rod through said first and second hinges comprises:
coupling a threaded extrusion to a non-threaded extrusion having a through-hole;
securing said threaded extrusion and non-threaded extrusion at each of said first hinges;
coupling a non-threaded extrusion at each of said second hinges with a thrust bearing and a lead screw collar located at opposite ends of said non-threaded extrusions; and
inserting said threaded rod through said first and second hinges wherein said threaded rod is threadedly engaged in said threaded extrusions at said first hinges and wherein said non-threaded extrusions at said second hinges are secured to said threaded rod using said lead screw collars.

31. The method of claim 30 wherein said non-threaded extrusion is a rectangular configuration.

32. The method of claim 30 wherein said non-threaded extrusion comprises a hex bar configuration.

33. The method of claim 32 further comprising inserting a disc spring between said threaded extrusion and said non-threaded extrusion to allow for misalignment between said non-threaded extrusion and said threaded extrusion to prevent said threaded rod from binding.

34. The method of claim 33 wherein said disc spring is a Belleville washer.
